(19) United States
(12) Patent Application Publication
(10) Pub. No.: US 2009/0162498 A1
(43) Pub. Date: Jun. 25, 2009

(54) GRAIN PRODUCTS HAVING A NON-SWEETENING AMOUNT OF A POTENT SWEETENER

(75) Inventors: Richard McArdle, Palatine, IL (US); Sandy Mui, Cary, IL (US); Marcus H. Parsons, Crystal Lake, IL (US); Andrew Sleyko, Chicago, IL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: The Quaker Oats Company, Chicago, IL (US)

(21) Appl. No.: 11/962,731

(22) Filed: Dec. 21, 2007

(51) Int. Cl. A23L 1/164; A23L 1/10; A23G 3/00

(52) U.S. Cl. 426/96; 426/618; 426/619; 426/103; 426/620

(57) ABSTRACT

Comestible grain products are provided, e.g. cereal, oatmeal, snack bars, etc., including at least one grain constituent and a non-sweetening amount of at least one potent sweetener. The non-sweetening amount of potent sweetener may comprise a natural potent sweetener, an artificial potent sweetener, or a mixture of both. The non-sweetening amount of potent sweetener can modify the taste of the comestible grain product by decreasing or eliminating one or more undesirable taste characteristics, creating or increasing one or more desirable taste characteristics, or any combination of these.

### TECHNICAL FIELD

This invention relates to comestible grain products with or without other ingredients, for example, grain products commonly known to consumers as cereal, snack bars, oatmeal, etc. In particular, this invention relates to grain products including a non-sweetening amount of a potent sweetener, having formulations suitable to meet market demand for alternative nutritional characteristics and/or taste characteristics.

### BACKGROUND

Grain products of various formulations have long been known. Improved and new formulations are desirable to meet market demands for new and different products. In particular, there is a perceived opportunity for grain products having alternative taste characteristics, including, for example, accentuation of flavor impact.

It is therefore an object of the present invention to provide new grain products having desirable taste properties. It is an object of at least certain embodiments of the invention to provide grain products having improved formulations. It is an object of at least certain embodiments of the invention to provide grain products having formulations incorporating a non-sweetening amount of one or more potent sweeteners, including natural and/or artificial potent sweeteners, and being suitable to meet market demand for alternative flavor profiles in grain products. It is an object of at least certain embodiments of the invention to provide non-sweetening amounts of potent sweeteners that can be used to impart one or more desirable taste characteristics to a grain product described here. These and other objects, features and advantages of the invention or of certain embodiments of the invention will be apparent to those skilled in the art from the following disclosure and description of exemplary embodiments.

### SUMMARY

In at least certain exemplary embodiments, the grain products disclosed here are based at least in part on the discovery of comestible grain products having a non-sweetening amount of one or more potent sweeteners to modify the taste of the grain product.

It has been discovered that a non-sweetening amount of a potent sweetener can modify the taste of comestible grain products, causing an increase in desirable taste characteristics, such as, for example, flavor perception, sweetness perception, or both, and/or a decrease in undesirable taste characteristics in the grain product, such as, for example, grassy flavor perception, bitter flavor perception, grainy flavor perception, salty flavor perception or any combination thereof.

In accordance with a first aspect, comestible grain products are provided that include at least one constituent of at least one grain and a non-sweetening amount of at least one potent sweetener. In certain exemplary embodiments, the potent sweetener comprises a natural sweetener such as a steviol glycoside, e.g., one or more of rebaudioside A and stevioside. In certain exemplary embodiments, the potent natural sweetener includes one or more of mogroside V, monatin, and glycyrrhizin. In certain exemplary embodiments, the potent sweetener comprises an artificial sweetener such as, e.g., aspartame, neotame, alitame, saccharin, acesulfame potassium, cyclamate, neohesperidin dihydrochalcone, and/or sucralose. In certain exemplary embodiments, the grain is corn, rice, wheat, oat, barley or any combination thereof. In certain exemplary embodiments, the comestible grain product also includes one or more additional ingredients, such as, e.g., a preservative, a color additive, a flavorant, a flavor enhancer, a fat replacer, a nutrient, an emulsifier, a stabilizer, a thickener, a binder, a texturizer, a pH control agent, an acidulant, a leavening agent, an anti-caking agent, a humectant, a dough strengthener, a dough conditioner or any combination thereof.

The comestible grain product may be sweetened or unsweetened. It may, for example, have a sweetening amount of one or more other sweeteners, e.g., a natural and/or artificial sweetener. In certain exemplary embodiments, the unsweetened, comestible grain product is a hot cereal, for example, oatmeal (such as, e.g., quick oats, rolled oats or steel cut oats), multigrain hot cereal, oat bran, cracked wheat, cream of rye, cream of wheat, cream of rice or any combination thereof. In certain exemplary embodiments, the unsweetened, comestible grain product comprises granola, muesli or both. In certain exemplary embodiments, the comestible grain product is a sweetened ready-to-prepare cereal, a sweetened ready-to-eat cereal, a sweetened snack, etc. The ready-to-prepare cereal may be partially cooked or uncooked. In certain exemplary embodiments, the comestible grain product is in the form of a bar, i.e., a snack bar, e.g., a single serving, individually packaged, one-piece snack bar.

In certain exemplary embodiments, the potent sweetener is present in an amount sufficient to reduce an undesirable taste characteristic, such as, for example, a grassy flavor, a bitter flavor, a grainy flavor, a sour flavor, a salty flavor or any combination thereof. In certain exemplary embodiments, the potent sweetener is present in an amount sufficient to increase a desirable taste characteristic such as, for example, sweetness, flavor perception, or both. The potent sweetener is present at a concentration below the sweet taste perception threshold in the particular grain product, typically, e.g., less than about 60 PPM, about 50 PPM, about 40 PPM, about 30 PPM, or about 20 PPM.

In accordance with another aspect, grain products are provided that include at least a base including at least one constituent of at least one grain, a coating enrobing at least a portion of the base, and a non-sweetening amount of a at least one potent sweetener, e.g., steviol glycosides, Lo Han Guo, mogroside V, monatin, glycyrrhizin, aspartame, neotame, alitame, saccharin, acesulfame potassium, cyclamate, neohesperidin dihydrochalcone, and/or sucralose, present in one or both of the base and the coating. In certain exemplary embodiments, the steviol glycoside is a rebaudioside such as, for example, rebaudioside A. In certain exemplary embodiments, the steviol glycoside is stevioside. One or both of the coating and the base optionally further include a natural nutritive sweetener selected from sucrose, fructose, glucose, invert sugar, glucose-fructose syrup and any combination thereof. Alternatively, the comestible grain product contains no sucrose, fructose, glucose, invert sugar or glucose-fructose syrup. The base can be, e.g., in the form of puffs, flakes, shreds, clusters, sheets or any combination thereof. In certain exemplary embodiments, the grain is selected from corn, rice, wheat, oat, barley and any combination thereof.

### DETAILED DESCRIPTION OF CERTAIN EXEMPLARY EMBODIMENTS

The present invention provides grain products having non-sweetening amounts of one or more potent sweeteners, for example, a potent natural sweetener and/or a potent artificial sweetener. It should be understood that grain products in accordance with this disclosure may have any of numerous different specific formulations or constitutions. The formulation of a grain product in accordance with this disclosure can vary to a large extent, depending upon such factors as the product's intended market segment, desired nutritional characteristics, flavor profile and the like. For example, it will generally be an option to add further ingredients to the formulation of particular grain product embodiments, including, e.g., to any of the grain product formulations described below.

As used herein, a “non-sweetening amount” refers to an amount of sweetener that, in the grain product as a whole, is not perceptible as sweet, as judged by a majority of persons that have tasted a sample containing the non-sweetening amount of sweetener. In certain exemplary embodiments, the grain product is not perceptibly sweetened by the low amount of potent sweetener included in the formulation of the product. In other exemplary embodiments, the non-sweetening amount of potent sweetener may enhance the inherent sweetness of a grain product, as discussed further herein. Also, in certain exemplary embodiments, the non-sweetening amount of potent sweetener can modify the taste of the comestible grain product by decreasing or eliminating one or more undesirable taste characteristics, creating or increasing one or more desirable taste characteristics, or any combination of these. As used herein, the terms increasing, decreasing, creating, eliminating, accentuating, and enhancing of a taste characteristic means perceptibly changing the taste characteristic compared with the perceptible level of taste characteristic in a correspondingly formulated grain product that does not include a non-sweetening amount of potent sweetener.

As used herein, the term “taste” refers to the flavor of the grain product and includes sweetness, sourness, bitterness, saltiness and umami (e.g., savoriness or meatiness). As used herein, the term “mouthfeel” refers to a tactile sensation a grain product gives to the mouth (i.e., due to physical and chemical interactions in the mouth). Mouthfeel is evaluated from initial perception on the palate through to swallowing. Mouthfeel and taste may overlap and/or impact each other.

As used herein, the term “undesirable taste characteristic” refers to one or more off-flavors that can be perceived in grain products, particularly in unsweetened grain products or grain products containing one or more whole grain constituents (such as, for example, oatmeal). Undesirable taste characteristics are known in the art and include, for example, but are not limited to, bitterness, sourness, graininess, grassiness, saltiness and any combination thereof.

As used herein, the term “desirable taste characteristic” refers to one or more desirable or attractive flavors or tastes that can be added to or enhanced in grain products described here. Desirable taste characteristics are known in the art and include, for example, but are not limited to, one or both of accentuation of flavor impact (e.g., flavor perception when eaten) and enhanced sweetness. In certain exemplary embodiments, a non-sweetening amount of a potent sweetener reduces or eliminates the need for additional flavor enhancers such as salt, MSG and the like, as discussed further herein.

In certain exemplary embodiments the non-sweetening amount of at least one potent sweetener in a grain product modifies the taste of the grain product but does not by itself contribute perceptible sweetness. In certain exemplary embodiments, a non-sweetening amount of a potent sweetener such as, for example, at least one of rebaudioside A, stevioside, mogroside V, monatin, glycyrrhizin, aspartame, neotame, alitame, saccharin, acesulfame potassium, cyclamate, neohesperidin dihydrochalcone, sucralose, and any combination of these, is typically an amount below about 60 PPM of the grain product. In certain exemplary embodiments, the non-sweetening amount of potent sweetener is between about 1 PPM and about 60 PPM, or is less than 20 PPM, less than 50 PPM or between about 20 PPM and 50 PPM. As used here, the non-sweetening amount of potent sweetener is the combined total amount of the potent sweetener in the grain product or, alternatively, in the formulation of the coating (if any) or the base. The non-sweetening amount of potent sweetener used will depend upon the desired level of taste modification such as, for example, an increase in a desirable taste characteristic and/or flavor perception and/or a decrease in one or more of grassy flavor, bitter flavor and grainy flavor for the grain product. The non-sweetening amount of potent sweetener used will also depend on the particular potent sweetener(s) used as they may differ in the ability to modify the taste of the grain product when used in non-sweetening amounts.

The various sweeteners included in the grain products disclosed here are edible consumables. By “edible consumables” is meant a food or an ingredient of a food for human or animal consumption. The sweetener or sweetening agent, as those terms are used here, can be a nutritive or non-nutritive, natural or artificial grain product ingredient or additive (or mixtures of them) which provides sweetness to the grain product, i.e., which in the context of the whole product is perceived by a substantial portion of the consuming public as sweet by the sense of taste. The perception of flavoring agents and sweetening agents may depend to some extent on the interrelation of elements. Flavor and sweetness may also be perceived separately, i.e., flavor and sweetness perception may be both dependent upon each other and independent of each other. For example, when a large amount of a flavoring agent is used, a small amount of a sweetening agent may be readily perceptible and vice versa. Thus, the oral and olfactory interaction between a flavoring agent and a sweetening agent in any given product may involve the interrelationship of elements.

As used herein, the term “nutritive sweetener” refers generally to sweeteners which provide significant caloric content in typical usage amounts, e.g., more than about 4.0 calories/gram. As used herein, a “non-nutritive sweetener” is one which does not provide significant caloric content in typical usage amounts, e.g., less than about 1.0 calorie/gram. A “low-calorie” sweetener imparts sweetness to a grain product and has a caloric content of less than about 3.0 calories/gram.

Nutritive sweeteners can collectively comprise about 0.05 to 75% of the final grain product (dry basis). In certain exemplary embodiments, nutritive sweeteners (e.g., sucrose) collectively comprise about 30 to 57% of the final grain product (dry basis) (e.g., 9 to 17 grams of sweetener (e.g., sucrose) per 30 gram serving size of grain). In other exemplary embodiments, nutritive sweeteners comprise less than 30% of the final grain product. In other exemplary embodiments, nutritive sweeteners comprise less than 5% of the final grain product.

As used herein, a “potent sweetener” means a sweetener which is at least twice as sweet as sugar, that is, a sweetener which on a weight basis requires no more than half the weight of sugar to achieve an equivalent sweetness. For example, a potent sweetener may require less than one-half the weight of sugar to achieve an equivalent sweetness in a grain product sweetened to a level of 10 degrees Brix with sugar. Potent sweeteners include both nutritive and non-nutritive sweeteners. In addition, potent sweeteners include both natural sweeteners and artificial sweeteners. Commonly accepted potency figures for certain potent sweeteners include, for example,

| | | |
|---|---|---|
| Cyclamate | 30 | times as sweet as sugar |
| Stevioside | 100-250 | times as sweet as sugar |
| Mogroside V | 100-300 | times as sweet as sugar |
| Rebaudioside A | 150-300 | times as sweet as sugar |
| Acesulfame-K | 200 | times as sweet as sugar |
| Aspartame | 200 | times as sweet as sugar |
| Saccharin | 300 | times as sweet as sugar |
| Neohesperidin dihydrochalcone | 300 | times as sweet as sugar |
| Sucralose | 600 | times as sweet as sugar |
| Neotame | 8,000 | times as sweet as sugar |

As used herein, the term “natural” is defined in accordance with the following guidelines: Raw materials for a natural ingredient exists or originates in nature. Biological synthesis involving fermentation and enzymes can be employed, but synthesis with chemical reagents is not utilized. Artificial colors, preservatives, and flavors are not considered natural ingredients. Ingredients may be processed or purified through certain specified techniques including at least: physical processes, fermentation, and enzymolysis. Appropriate processes and purification techniques include at least: absorption, adsorption, agglomeration, centrifugation, chopping, cooking (baking, frying, boiling, roasting), cooling, cutting, chromatography, coating, crystallization, digestion, drying (spray, freeze drying, vacuum), evaporation, distillation, electrophoresis, emulsification, encapsulation, extraction, extrusion, filtration, fermentation, grinding, infusion, maceration, microbiological (rennet, enzymes), mixing, peeling, percolation, refrigeration/freezing, squeezing, steeping, washing, heating, mixing, ion exchange, lyophilization, osmose, precipitation, salting out, sublimation, ultrasonic treatment, concentration, flocculation, homogenization, reconstitution, enzymolysis (using enzymes found in nature). Processing aids (currently defined as substances used as manufacturing aids to enhance the appeal or utility of a food component, including clarifying agents, catalysts, flocculants, filter aids, and crystallization inhibitors, etc. See 21 CFR §170.3(o)(24)) are considered incidental additives and may be used if removed appropriately. As used herein, the term “artificial” is anything that is not natural, e.g., anything that is made by man.

In certain exemplary embodiments, the non-sweetening amount of potent natural sweetener in the grain products disclosed here may be, for example, any one or more of the steviosides, rebaudiosides and related compounds suitable for sweetening. These compounds can be obtained by extraction or the like from the Stevia plant. Stevia (e.g., Stevia rebaudiana Bertoni) is a sweet-tasting plant, whose leaves contain a complex mixture of natural sweet diterpene glycosides. Steviol glycosides and rebaudiosides are components of Stevia that can contribute sweetness when used in sweetening amounts and which can contribute alternative flavor characteristics or effects to the grain products disclosed here in which they are used in non-sweetening amounts. Typically, Stevia is found to include stevioside (4-13% dry weight), steviolbioside (trace), the rebaudiosides, including rebaudioside A (2-4%), rebaudioside B (trace), rebaudioside C (1-2%), rebaudioside D (trace), and rebaudioside E (trace), and dulcoside A (0.4-0.7%). Such compounds are referred to herein as steviol glycosides. Any suitable level of purity may be used, e.g., 92%, 97% or higher.

In certain exemplary embodiments, the non-sweetening amount of potent natural sweetener in the grain products disclosed here may be, for example, the non-nutritive, potent sweetener Lo Han Guo. Lo Han Guo has various different spellings and pronunciations, can be obtained from fruit of the plant family Cucurbitaceae, tribe Jollifieae, subtribe Thladianthinae, genus Siraitia. Lo Han Guo often is obtained from the genus/species S. grosvenorii, S. siamensis, S. silomaradjae, S. sikkimensis, S. africana, S. borneensis, and S. taiwaniana. Suitable fruit includes that of the genus/species S. grosvenorii, which is often called Lo Han Guo fruit. Lo Han Guo contains triterpene glycosides or mogrosides (e.g., mogroside V), which constituents may be used as Lo Han Guo sweeteners. Lo Han Guo can be used as the juice or juice concentrate, powder, etc. In certain exemplary embodiments, Lo Han Guo juice contains at least about 0.1%, e.g., from 0.1% to about 15%, mogrosides, such as mogroside V, mogroside IV, 11-oxo-mogroside V, siamenoside and mixtures thereof. LHG can be produced, for example, as discussed in U.S. Pat. No. 5,411,755.

In certain exemplary embodiments, the non-sweetening amount of potent sweetener in the grain products disclosed here may be, for example, one or more artificial potent sweeteners. Artificial potent sweeteners suitable for at least certain exemplary embodiments include, for example, aspartame, neotame, alitame, sodium saccharin, calcium saccharin, acesulfame potassium, sodium cyclamate, calcium cyclamate, neohesperidin dihydrochalcone, and sucralose. It will be within the ability of those skilled in the art, given the benefit of this disclosure, to select suitable potent sweeteners (e.g., one or combination of natural potent sweeteners, one or a combination of artificial potent sweeteners, or a combination of natural and artificial potent sweeteners) for a particular embodiment of the grain products disclosed here employing a non-sweetening amount of a potent sweetener.

Grain products disclosed here comprising a non-sweetening amount of at least one potent sweetener can be utilized as hot cereals, ready-to-eat cereals and/or snacks. Grain products disclosed here can include one or more edible grains including, but not limited to, e.g., corn, rice (e.g., brown or white), wheat (e.g., spelt, einkom, emmer, durum and the like), buckwheat, oat, barley, amaranth, fonio, quinoa, teff, millet, sorghum, triticale, flax, wild rice and the like and any combination thereof. The terms “cereal products” and “grain products” are used interchangeably herein.

Grain products disclosed here can include one or more constituents of one or more grains. As used herein, the term “grain constituent” is intended to include any component of a whole grain, e.g., the whole grain kernel, the germ, the bran, the endosperm and any combination thereof. Whole grains typically refer to the germ, bran and endosperm of a grain. Refined grains typically refer to grain products in which the bran and most or all of the germ have been removed, leaving primarily or only the endosperm. As used herein, the term “grain constituent” includes any combination of one or more components of a grain that have been ground into flour, cut into pieces of a variety of sizes or used whole. Grain products disclosed here can be sweetened (e.g., containing a sweetening amount of one or more sweeteners described further herein in addition to a non-sweetening amount of potent sweetener) or unsweetened (e.g., containing a non-sweetening amount of potent sweetener in the absence of a sweetening amount of other sweeteners).

As used herein, the term “ready-to-eat cereal” refers to a grain product that may be eaten without the need for further preparation save for the optional addition of a liquid, such as, for example, milk, a milk substitute, juice or the like. As used herein, the term “snack” refers to a grain product that can be consumed from the container optionally without further preparation. Snack grain products include, for example, snack bars such as, for example, grain bars, breakfast bars, granola bars (e.g., crunchy and/or soft), nutrition bars, diet bars and the like. The ready-to-eat grain products and/or snack grain products described herein can be fashioned into a variety of physical forms, such as, e.g., puffs, flakes, shreds, clusters, sheets and any combination thereof.

As used herein, the term “puff” is intended to refer to an expanded grain piece prepared from one or more grains and/or grain constituents. Various methods of making puffs are well known in the art and are described in, for example, U.S. Pat. Nos. 4,409,250, 4,620,981, 5,176,936 and 6,319,534. Methods of making puffs are described further below. The term “puffed grain pieces” is used herein in its conventional usage to refer to low density grain pieces wherein each piece typically has a density ranging from about 0.06 to 0.15 g/cc (4.3 to 10 oz. per 124 inch³) or from about 0.09 to 0.14 g/cc (5 to 10 oz. per 124 inch³). Puffs in various embodiments of the grain products disclosed here can be uniform or non-uniform in size, shape, etc.

As used herein, the term “flake” is intended to refer to a grain piece formed by flaking a cooked grain pellet or grain or grain constituent. Methods of making flakes are well known in the art and described in, for example, U.S. Pat. Nos. 5,919,503 and 7,105,196. Methods of making flakes are described further below. Wet flakes typically range in thickness from about 350 to 900 μm (0.015 to 0.035 in.) in thickness. Flakes in various embodiments of the grain products disclosed here can be uniform or non-uniform in size, shape, etc.

As used herein, the term “shred” means an elongate grain product piece, e.g., a cereal piece, in the shape of a long, narrow, thin strip. Shreds are typically manufactured by passage of a cooked grain (e.g., wheat berries for shredded wheat) between pairs of rollers, one smooth and one grooved (e.g., a shred mill). Methods of making shreds are well known in the art and are described in, for example, U.S. Pat. Nos. 5,270,063, 5,464,644 and 5,972,413. Shreds can optionally be formed into a variety of shapes such as, for example, biscuits (e.g., shredded wheat biscuits). Shreds in various embodiments of the grain products disclosed here can be uniform or non-uniform in size, shape, etc.

As used herein, the term “cluster” is intended to refer an agglomerated grain piece such as, for example, granola. Methods of making clusters are well known in the art and described in, for example, U.S. Pat. No. 6,837,682. Clusters in various embodiments of the grain products disclosed here can be uniform or non-uniform in size, shape, etc.

As used herein, the terms “sheet” or “sheeted” are intended to refer to a grain product piece having one or more broad, thin surfaces. Methods of making sheets and sheeted grain products are well known in the art and described in, for example, U.S. Pat. Nos. 5,176,936 and 6,746,707 and U.S. Patent Application No. 2003/0134010. Sheets and sheeted pieces in various embodiments of the grain products disclosed here can be uniform or non-uniform in size, shape, etc.

As used herein, the term “hot cereal” is intended to include, for example, but is not limited to, a grain product that is suitable to be heated prior to eating, e.g., heated by combining the grain with one or more liquids (e.g., milk, milk substitute, juice, water or the like) and directly heating the grain, for instance using a conventional cooking means, such as, for example, a stovetop, conventional oven, convection oven, crock-pot, microwave oven or the like. Alternatively, hot cereal may be made by combining the grain product with one or more heated liquids (e.g., heated milk, heated milk substitute, heated juice, heated water or the like). In exemplary embodiments, these two methods can be combined to make hot cereal. In other exemplary embodiments, the hot cereal is suitable also for the alternative of being prepared for consumption without first heating the grain product. Hot cereals include, for example, but are not limited to, oatmeal (e.g., instant, rolled, steel cut, etc.), porridge, multigrain, oat bran, cracked wheat, cream of rye, cream of wheat (e.g., farina), cream of rice, grits and the like.

In certain exemplary embodiments, the grain products disclosed here may include, for example, only the grain product (e.g., shredded wheat, oatmeal or the like) and a non-sweetening amount of one or more potent sweeteners, such as rebaudioside A, stevioside, mogroside V, monatin, glycyrrhizin, aspartame, neotame, alitame, saccharin, acesulfame potassium, cyclamate, neohesperidin dihydrochalcone, sucralose, or a combination of any of them. In other exemplary embodiments, the grain products disclosed here optionally include, for example, one or more components in addition to the grain product and non-sweetening amount of potent sweetener. These optional components include, but are not limited to, any or all of the following: preservatives, a sweetening amount of a sweetener, color additives, flavorants, flavor enhancers, fat replacers, nutrients, emulsifiers, stabilizers, thickeners, binders, texturizers, pH control agents, acidulants, leavening agents, anti-caking agents, humectants, dough strengtheners, dough conditioners and the like. Information on each of these components is well known and can be obtained from the U.S. Food and Drug Administration, Center for Food Safety and Applied Nutrition (CFSAN).

In certain exemplary embodiments, the grain products disclosed here may optionally include one or more preservatives. Preservatives are typically used to prevent food spoilage from bacteria, molds, fungi yeast and the like; slow or prevent changes in color, flavor and/or texture, and/or delay rancidity; and/or maintain freshness of the grain products disclosed here. Suitable preservatives for at least certain exemplary embodiments of the grain products disclosed here include, for example, but are not limited to, ascorbic acid, citric acid, sodium benzoate, calcium propionate, sodium erythorbate, sodium nitrite, sodium chloride, calcium sorbate, potassium sorbate, BHA, BHT, EDTA, tocopherols (e.g., vitamin E) and the like. In certain exemplary embodiments the preservatives employed in the grain products disclosed here generally range from about 0 to about 5 weight percent of the total weight of the grain product or from about 1 to about 3 weight percent, or are present at about 1 weight percent.

In certain exemplary embodiments, grain products may include, in addition to the non-sweetening amount of one or more potent sweeteners, a sweetening amount of one or more natural or artificial sweeteners. As used herein, the term “sweetening amount” refers to an amount of a sweetener that, in the grain product as a whole, is perceptible as sweet as judged by a majority of persons that have tasted a sample containing the sweetening amount of sweetener. Sweeteners suitable for use in sweetening amounts in various embodiments of the grain products disclosed here comprising a non-sweetening amount of potent sweetener include, e.g., other natural and artificial or synthetic sweeteners. Sweetening amount of suitable sweeteners and combinations of sweeteners are selected for the desired nutritional characteristics, taste profile for the grain product, sweetness and other organoleptic factors. Sweeteners suitable for at least certain such exemplary embodiments include a sweetening amount of one or more natural non-nutritive sweeteners such as, for example, sorbitol, mannitol, xylitol, D-tagatose, erythritol, malitol, maltose, lactose, fructo-oligosaccharides, xylose, arabinose, isomalt, lactitol, maltitol, trehalose, ribose, protein sweeteners, such as, for example, thaumatin, monellin, brazzein, L-alanine and glycine and any combination thereof.

The grain products disclosed here are based in part on the discovery that a non-sweetening amount of one or more potent sweeteners can be used to alter the taste profile of a grain product, producing a grain product having a favorable taste profile and/or sweetness. Optionally, certain exemplary grain product embodiments also employ a sweetening amount of nutritive, natural crystalline or liquid sweetener such as a sweetening amount of, for example, sucrose, fructose, glucose, glucose-fructose syrup from natural sources such as apple, chicory, honey, etc., e.g., glucose-fructose syrup, e.g., high fructose corn syrup, invert sugar, maple syrup, maple sugar, honey, brown sugar molasses, e.g., cane molasses, such as first molasses, second molasses, blackstrap molasses, and sugar beet molasses, sorghum syrup, and/or others, and mixtures of any of them. Exemplary artificial sweeteners suitable for use as an optional additional sweetener in at least certain embodiments of the grain products disclosed here include a sweetening amount of, for example, aspartame, neotame, alitame, saccharin, acesulfame potassium, cyclamate, neohesperidin dihydrochalcone, and/or sucralose, and other such potent sweeteners, and mixtures of any of them, as further discussed below. In certain exemplary embodiments, grain products having a non-sweetening amount of one or more potent natural sweeteners employ a sweetening amount of artificial potent sweetener. Such artificial potent sweeteners include peptide based sweeteners, for example, acesulfame potassium, aspartame, neotame, and alitame, and non-peptide based sweeteners, for example, sodium saccharin, calcium saccharin, acesulfame potassium, sodium cyclamate, calcium cyclamate, neohesperidin dihydrochalcone, sucralose, and mixtures of any of them. It will be within the ability of those skilled in the art, given the benefit of this disclosure, to select suitable additional or alternative sweeteners for use in a sweetening amount in various embodiments of the beverage products comprising a non-sweetening amount of a potent sweetener disclosed here.

In at least certain exemplary embodiments of the grain products disclosed here, combinations of at least one potent natural sweetener and one or more natural, nutritive sweeteners and/or one or more artificial sweeteners with one or more natural non-nutritive or nutritive potent sweeteners are used to provide the sweetness and other aspects of desired taste profile and nutritive characteristics. It should also be recognized that certain such sweeteners will, either in addition to or instead of, act as tastents, masking agents or the like in various embodiments of the grain products disclosed here, e.g., when used in amounts below its (or their) sweetness perception threshold in the grain product in question as discussed further herein.

In certain exemplary embodiments, the grain products disclosed here may optionally include one or more color additives. Color additives can be used to offset color loss due to exposure to light, air, temperature extremes, moisture and/or storage conditions; correct natural variations in color; enhance colors that occur naturally; and/or provide for or enhance color of “fun” food embodiments of the grain products disclosed here. Color additives include, for example, but are not limited to, FD&C Blue No. 1, FD&C Blue No. 2, FD&C Green No. 3, FD&C Red No. 3, FD&C Red No. 40, FD&C Yellow No. 5, FD&C Yellow No. 6, Orange B, Citrus Red No. 2, annatto extract, beta-carotene, grape skin extract, carmine, cochineal extract, paprika oleoresin, caramel color, fruit juice, vegetable juice, saffron, water soluble dyes and the like.

In certain exemplary embodiments, the comestible grain products disclosed here may optionally include one or more flavorants. Flavorants are typically used to add one or more specific natural and/or synthetic flavors to the grain products disclosed here. Flavorants can include one or more natural flavorings, artificial flavorings, spices and various combinations thereof. Exemplary flavorants include, for example, but are not limited to, vanilla, cinnamon, nutmeg, malt, chocolate, nut flavor(s), fruit flavor(s) (e.g., such as juices, extracts, purees, dried fruits and the like or mixtures thereof). Essentially any fruit flavorant can be used, with the most common being apple, peach, pear, apricot, raspberry, blueberry, strawberry, boysenberry, lemon, orange, pineapple or raisin. In certain exemplary embodiments, a strawberry flavorant is used.

In certain exemplary embodiments, the comestible grain products disclosed here may optionally include one or more flavor enhancers. Flavor enhancers are typically used to enhance flavors already present in the grain products disclosed here. Typically, flavor enhancers do not provide their own separate flavor, such as a flavorant would. Flavor enhancers can be one or more natural enhancers, artificial enhancers or combinations thereof. Flavor enhancers include, for example, but are not limited to, sodium chloride, monosodium glutamate (MSG), monopotassium glutamate, maltol, ethyl maltol, nucleotide-containing compositions derived from shiitake or other suitable mushrooms, disodium succinate, whey proteins, hydrolyzed soy protein, autolyzed yeast extract, disodium guanylate, disodium inosinate, ascorbic acid, malic acid, tartaric acid, citric acid and the like.

In certain exemplary embodiments, the comestible grain products disclosed here may optionally include one or more fat replacers. Fat replacers are typically used to provide expected texture and/or a creamy mouthfeel in grain products (e.g., reduced-fat grain products) disclosed here. Fat replacers include, for example, but are not limited to, Olestra, cellulose gel, carrageenan, polydextrose, modified food starch, microparticulated egg white protein, guar gum, xanthan gum, whey protein concentrate and the like.

In certain exemplary embodiments, the comestible grain products disclosed here may optionally include one or more antioxidants. Antioxidants are typically used in grain products to stabilize free radicals before they can react and cause oxidative harm, e.g., after ingestion, in the grain products disclosed here. Antioxidants include, for example, but are not limited to, ascorbic acid, glutathione, vitamin A, vitamin C, vitamin E (e.g., tocopherols and tocotrienols), vitamin B₆, vitamin B₁₂, lipoic acid, uric acid, carotenes (e.g., beta- and retinol), ubiquinone, selenium, lycopene, folate, magnesium, carotenoids, zinc, lutein, zeaxanthin, anthocyanidins, flavanols and catechins, epicatechins, procyanidins, proanthocyanidins, flavonones, isothiocyanates (e.g., sulforaphane), phenols (e.g., caffeic acid, ferulic acid), sulfides/thiols (e.g., diallyl sulfide, allyl methyl trisulfide, dithiolthiones) and the like.

In certain exemplary embodiments, the comestible grain products disclosed here may optionally include one or more nutrients. Nutrients are typically used to replace one or more vitamins and minerals lost during processing of a grain product disclosed here (i.e., enrichment) and/or to add one or more nutrients that may be lacking in a grain product disclosed here (i.e., fortification). One or more grain comestible products described herein may optionally be fortified with vitamins and minerals.

Certain exemplary embodiments of the comestible grain products described here may optionally contain vitamins such as, for example, vitamins A, D, E, K, C, thiamin, riboflavin, niacin, vitamin B₆, folate, vitamin B₁₂, biotin, and/or pantothenic acid. In certain exemplary embodiments, the comestible grain products disclosed here may optionally include one or more vitamins such as, for example, A precursors (e.g., pro-vitamin A, carotenoids and the like), including, for example, β-carotene, α-carotene, β-apo-8′carotenal, cryptoxanthin and the like. Vitamin A esters (e.g., retinyl palmitate, retinyl acetate and the like) can also be used. Vitamin D can be selected from, for example, cholecalciferol (D³), ergocalciferol (D₂) and their biologically active metabolites and precursors such as, for example, 1-alpha-hydroxy vitamin D, 25-hydroxy vitamin D, 1,25-dihydroxy vitamin D and the like. In certain exemplary embodiments, all-rac α-tocopherol and RRR-alpha-tocopherol and their esters are used as a source for vitamins. Sources of vitamin E include d1-alpha tocopherol (all-rac) and its esters, such as, for example, d1-α-tocopheryl acetate and succinate, d1-alpha-tocopherol (RRR) and its esters, d-alpha-tocopherol and its esters, beta-tocopherol, gamma-tocopherol, and their esters, tocopheryl nicotinate and the like. Vitamin K can be selected from phylloquinone (K₁), menaquinone (K₂) and menadione and their salts and derivatives. L-ascorbic acid is exemplary as a vitamin C source, however other forms of vitamin C, for example, D-ascorbic acid, D-dehydroascorbic acid, L-isoascorbic acid, L-dehydroascorbic acid and esters of ascorbic acid (e.g., ascorbyl palmitate) may also be used. The hydrochloride and nitrate salts of thiamin and thiamin alkyl disulfides such as, for example, the prophyidisulfide, tetrahydrofurfuryl disulfide, O-benzoyl disulfide can be used. The hydrochloride and nitrate salts of thiamin are highly preferred. The sources of riboflavin are selected, for example, from crystalline riboflavin coenzyme forms of riboflavin such as, for example, flavin adenine dinucleotide, flavin adenine mononucleotide, riboflavin 5′-phosphate and their salts. Sources of niacin include nicotinic acid, nicotinamide, the coenzyme forms of niacin such as, for example, nicotinamide adenine dinucleotide and nicotinamide adenine dinucleotide phosphate. Vitamin B₆ can be selected from hydrochloride salts or 5′-phosphates of pyridoxine, pyridoxamine and pyridoxal. Folate can be in the form of folic acid, mono- or polyglutamyl folates, dihydro and tetrahydro folates, methyl and formyl folates. Sources of vitamin B₁₂ are, for example, cyanocobalamin, methylcobalamin, 5′-deoxy-adenosylcobalamin and the like. Sources of biotin can be selected from D-biotin, oxybiotin, biocytin, biotinol and the like. The sources of pantothenic acid can be in the form of salts such as, for example, calcium pantothenate or as panthenol, or in the form of coenzyme A.

In certain exemplary embodiments, comestible grain products disclosed here may optionally be fortified with minerals such as, for example, calcium, phosphorus, magnesium, iron, zinc, iodine, selenium, copper, manganese, fluoride, chromium, molybdenum, sodium, potassium, and chloride. The minerals can be in the form of any of the well known salts including carbonate, oxide, hydroxide, chloride, sulfate, phosphate, pyrophosphate, gluconate, lactate, acetate, fumarate, citrate, malate, amino acids and the like for the cationic minerals and sodium, potassium, calcium, magnesium and the like for the anionic minerals. The particular salt used and the concentration used will depend upon their interaction with other food product ingredients.

In certain exemplary embodiments, a comestible grain product disclosed here can optionally include trace elements of certain minerals, such as, for example, copper, iron, selenium, magnesium, manganese, zinc, and mixtures thereof. Conventional ingredients for vitamins and minerals can be employed to provide the desired trace elements. For example, iron can be provided by reduced iron, iron sulfite, ferric sodium pyrophosphate, and/or iron fumarate. Copper can be provided by Cu₂O, CuCl₂, CuSO₄ and mixtures thereof. Magnesium can be provided by MgO, MgCl₂, MgCO₂, Mg(OH)₂, magnesium acetate and mixtures thereof. Zinc can be provided by, for example Zn-citrates, Zn-gluconates, Zn-stearates, Zn-amino acid chelates, Zn-ascorbates and mixtures thereof.

In certain exemplary embodiments, the comestible grain products disclosed here may optionally include one or more emulsifiers. Emulsifiers are typically used to allow smooth mixing of grain product ingredients and/or to prevent separation of grain product ingredients disclosed here. Emulsifiers include, for example, but are not limited to, soy lecithin, monoglycerides, diglycerides, egg yolks, polysorbates, sorbitan monostearate and the like.

In certain exemplary embodiments, the comestible grain products disclosed here may optionally include one or more stabilizers, thickeners or texturizers. Stabilizers, thickeners, binders and texturizers are typically used to produce a uniform texture and/or to improve the mouthfeel of a grain product disclosed here. Stabilizers, thickeners, binders and texturizers include, for example, but are not limited to, gelatin, pectin, guar gum, carrageenan, xanthan gum, whey and the like.

In certain exemplary embodiments, the comestible grain products disclosed here may optionally include one or more pH control agents or acidulants. PH control agents and acidulants are typically used to control acidity and/or alkalinity and/or prevent spoilage of the grain products described disclosed here. PH control agents and acidulants include, for example, lactic acid, citric acid, ammonium hydroxide, sodium carbonate and the like.

In certain exemplary embodiments, the comestible grain products disclosed here may optionally include one or more leavening agents. Leavening agents are typically used to promote rising of grain products disclosed here. Leavening agents include, for example, but are not limited to, baking soda, monocalcium phosphate, calcium carbonate and the like.

In certain exemplary embodiments, the comestible grain products disclosed here may optionally include one or more anti-caking agents. Anti-caking agents are typically used to keep powdered grain components disclosed here free-flowing and/or to prevent moisture absorption. Anti-caking agents include, for example, but are not limited to, calcium silicate, iron ammonium citrate, silicon dioxide and the like.

In certain exemplary embodiments, the comestible grain products disclosed here may optionally include one or more humectants. Humectants are typically added to grain products disclosed here to retain moisture, e.g., of components such as, for example, shredded coconut, marshmallows, confections and the like. Humectants include, for example, but are not limited to, glycerin, sorbitol and the like.

In certain exemplary embodiments, the comestible grain products disclosed here may optionally include one or more dough strengtheners or conditioners. Dough strengtheners and conditioners are typically added to grain products disclosed here to produce a stable dough. Dough strengtheners and conditioners include, for example, but are not limited to, ammonium sulfate, azodicarbonamide, L-cysteine and the like.

In certain exemplary embodiments, the amount and type of these components that may optionally be employed to produce the comestible grain products described here depend upon the desired color, flavor, texture, nutritional content or other benefit of the final food bars being produced. All of these optional components are commercially available from sources known by those of skill in the art.

Grain Product Base Processing

As used herein, the terms “base,” “spoonable base,” “grain product base,” and “cereal base” are used interchangeably, and refer to edible pieces of grain products such as, for example, puffs, flakes, shreds, sheets, clusters and any combination thereof. A grain product base may be suitable for consumption as is or, optionally, may require additional processing as described here (e.g., one or more of cutting, shredding, enrobing, cooking, pre-cooking and the like). A grain product base can comprise a wide variety of shapes, densities, sizes and compositions. A grain product base can be produced, for example, as discussed in U.S. Pat. No. 5,709,902 or by any other art-recognized methods. As discussed in U.S. Pat. No. 5,709,902, a grain product base can include a plurality of individual pieces of wet, unexpanded, ready-to-eat grain compositions such as, for example, wet flakes, shreds, wet sheeted dough pellets, biscuits, granola and mixtures thereof. In certain exemplary embodiments, wet, untoasted grain pellets having a moisture content of about 12% to 25% or of about 16% to 20% are used as the grain product base. In other exemplary embodiments, puffed pieces including a non-sweetening amount of a steviol glycoside are conventionally toasted after puffing and, in certain exemplary embodiments, thereafter coated and/or dried.

In the conventional preparation of a grain product, a dry blend of starchy grain ingredients with or without a bran or fiber constituent is well mixed and then combined with water and other grain product ingredients (e.g., such as salt(s), sweetener(s), malt or other flavors, starches and the like and combinations thereof as discussed further herein) and mixing with heat to cook or gelatinize the starchy component of the grain composition. The gelatinized or cooked grain, upon further mixing, forms a cooked farinaceous dough. A variety of well known cooking methods and equipment can be used to prepare a cooked grain dough. In certain exemplary embodiments, the wetted grain blend can be processed in a short cook time cooker extruder (e.g., a single or twin screw extruder) or in an extended cook time cooker such as a pressurized and agitated steam cooker each of which form the cooked grain dough which in turn can be fed to a grain pellet forming extruder to form grain pellets. In other exemplary embodiments, the cooking and dough forming steps are performed simultaneously in a high pressure cooker extruder equipped with a pellet-forming die head. Cooked grain dough pellets formed in this manner typically range from about 18% to 30% moisture.

In certain exemplary embodiments, the cooked grain dough is formed into a dough sheet by sheeting, which sheet is then sectioned, e.g., by longitudinally cutting and transversely sheeting, to form pellets in sheet form. The pellets can then be dried in a conventional pellet dryer and optionally tempered such as in a temper bin to adjust or equilibrate the moisture content for further processing.

In certain exemplary embodiments, the grain product base is a puffed grain. Pellets having a moisture content of about 10% to 14% can be puffed such as by a conventional puffing gun to form a puffed ready-to-eat grain product base, especially oat based pieces in the form of rings or other compositions in the form of spherical puffed grain pieces. The puffed base grain pieces exit the puffing gun at a moisture content of about 6%. In still other embodiments, the puffed pieces are prepared without an intermediate pellet forming step by direct expansion at the die head of a cooker extruder, e.g., a twin screw cooker extruder. In other exemplary embodiments, puffed pieces are prepared by oven puffing or microwave puffing. Such methods are well known in the art.

The puffed grain can optionally be toasted in an oven of conventional design such as a fluidized bed-type oven. While the air temperature and duration for oven toasting the puffed grain product will necessarily vary according to the size and shape of the grain product and its moisture content, it has been found that an oven temperature in the range of about 335° F. to 400° F. (about 168° C. to about 204° C.) applied to a heat-set grain product for about 1 to 2 minutes is satisfactory to dry an extruded, irregular, nugget shaped grain product of about 3/16″ to 5/16″ (about 4.7 mm to about 7.9 mm) in diameter to a moisture content at which the heat set grain product retains its fully expanded structure and is therefore structurally stable.

In certain exemplary embodiments, the grain product base is a flaked grain. Flakes can be made using a variety of methods known in the art. In certain exemplary embodiments, dried non-circular pellets are used to form wet flakes using conventional flaking rolls. Thereafter, the wet flakes so formed are subjected to toasting to form toasted, dried grain flakes. A grain flake can be tenderized, toasted and partially expanded by rapid heating of wet flakes which converts the dense, hard, wet flakes into more palatable, porous, tender flakes. The toasting operation can also enhance the color and flavor of the finished grain product. Toasting is typically accomplished by heating the wet flakes to a temperature of between about 93.3 to 315.5° C. (200 to 600° F.) until a moisture content of approximately 2 to 5% is obtained. Toasting of the wet flakes can be practiced in conventional dryers, vacuum dryers or other commercial baking equipment.

In certain exemplary embodiments, cooked whole grains are tempered and shredded in shredding rolls to form wet grain shreds. In other exemplary embodiments, the shreds can be laminated or otherwise arranged or formed into biscuits of various sizes to form the grain product base. In other exemplary embodiments, the shredded grain is formed into layers to form a shredded grain biscuit. Optionally, the shredded biscuits can be filled, e.g., with a fruit filling or a confection (e.g., a water-based icing composition).

Within this general outline of grain processing, a wide variety of particular methods and variations can be used. In the production of a ready-to-eat grain, various general art-known procedures can be used depending upon the desired form, type or condition of the final product.

Enrobing

As used herein, the term “enrobe” refers to the optional step of providing a coating composition (e.g., a coating composition including a sweetening component) to a grain product. In certain exemplary embodiments, the coating is uniformly applied to the surface of a grain piece to evenly coat the exterior. In other exemplary embodiments, the coating is applied to portions of the surface of a grain piece, e.g., between about 10% and about 90% of the surface of the grain piece. In other exemplary embodiments, the coating is selectively deposited on particular locations in a known manner. Enrobing may be performed before and/or after the toasting or drying step described below.

In certain exemplary embodiments, a coating composition including a sweetening component is applied to a grain product piece(s) described here. The term “coating composition,” as used herein, is a general collective term that includes both sweetening syrups having no solids or oil components present (e.g., sugar syrups) as well as other compositions that include an oil component, whether or not emulsified, and/or solids. Well known coating application techniques can be employed. Generally, sweetening syrups comprise 20 to 50% sucrose, 0 to 30% corn syrup, 0 to 25% oil and 9 to 75% moisture. In certain exemplary embodiments, the sweetening syrup includes a non-sweetening amount of a steviol glycoside (e.g., a rebaudioside).

In certain exemplary embodiments, one or more coating compositions described here can be applied to grain product piece(s) using a variety of techniques known in the art, e.g., using an enrober drum or other coating vessel or equipment using a liquid coating composition. Generally, a useful technique involves tumbling. The grain piece(s) and liquid coating composition are each charged in any order to a rotating drum and tumbled for a sufficient time to enrobe the grain piece(s) with a coating. In certain exemplary embodiments, a liquid coating composition is added after the grain piece(s) have been added to the drum. In other exemplary embodiments, a liquid coating composition is sprayed over the grain piece(s), which obviates a need for tumbling. In other exemplary embodiments, a dry coating process can be used to enrobe the grain piece(s) with a coating composition. In other exemplary embodiments, a coating composition can also include or be co-applied with particulates such as, for example, fruit and nut pieces and/or small grain flakes. Enrobing methods and apparatuses are well known in the art and are described in, for example, U.S. Pat. Nos. 4,079,151, 4,880,645, 5,453,383, 5,516,541, 5,709,902, 5,968,572, 6,174,553 and 7,163,708.

In certain exemplary embodiments, the coating composition additionally comprises about 0.1% to 15% of an optional flavor constituent and/or vitamins. The addition of a flavor constituent to the coating composition can be used to replace some or all of a sugar component (e.g., sucrose), to augment flavor development and/or to compensate for flavor losses that can occur from the toasting step(s) described here. These steps, due to their heat application, tend to drive off the volatile flavor constituents leading to flavor degradation or loss. Heat tolerant high potency sweeteners can also be used (e.g., acesulfame K). However, heat sensitive high potency sweeteners (e.g., aspartame) should not be used exclusively since the rigorous high temperatures of the subsequent drying step can cause degradation of these expensive high potency sweeteners. In certain exemplary embodiments, optional vitamins used in this step are heat tolerant. A particularly useful combination of vitamins for topical application consist of vitamins C, A and D and mixtures thereof. In other exemplary embodiments, the coating composition can additionally comprise about 1% to 20% of a reaction flavor ingredient. Such a reaction flavor ingredient reacts due to the elevated temperature of the toasting step. The reaction can be with the other coating composition ingredients or with the grain piece itself. Exemplary reaction flavor ingredients include non-fat dry milk solids, malt and other grain syrups. Other suitable reaction flavors are commercially available from various commercial vendors.

If a “frosted” appearance for the sugar coating is desired (as compared with a clear or glossy coating appearance), then manipulating the sugar content and crystal structure in known manner (e.g., adding crystalline sugar) can provide a frosted appearance. A frosted appearance can also be provided by adding small amounts of titanium dioxide (TiO₂) to the coating composition. Suitable TiO₂ concentrations can range from about 0.02% to about 0.5% of the coating composition. Addition of a powdered white pigment can be added to the other frosted coating components to provide a pleasing, initial frosted appearance as well as providing a resistance to dissolution in milk.

Toasting/Drying the Grain Product Base

In certain exemplary embodiments, one or more drying or toasting steps are performed to reduce the moisture of the grain product and obtain a finish moisture content level not exceeding 15% by weight. In certain exemplary embodiments, the finish moisture content is from about 1% to 6% or about 2% to 4% by weight. The one or more drying steps can be performed by a variety of heating methods (e.g., toasting, baking, microwaving and the like) and/or dehydrating methods known in the art.

In certain exemplary embodiments, the external surface of the grain piece, during at least a portion of the drying step, reaches a temperature of ≧250° F. (≧121° C.). The drying step can be performed by toasting, baking or other steps involving moisture reduction. For an enrobed grain piece, it is important for the formation of an optional sugar crust feature that the temperature gradient be such that the higher temperature is external to the grain product base. For such applications, high intensity microwave heating techniques which create a reverse or internal gradient would not be suitable since the desired external crust layer would not be formed.

If desired, a pre-drying step can be performed prior to a high temperature or toasting step. The pre-drying step can include an initial drying step with forced hot air having a temperature of about 350 to 475° F. (about 177° C. to 246° C.) to an intermediate moisture of about 6% to 10%, and a final drying step with forced hot air having a temperature of about 275 to 375° F. (about 135° C. to 191° C.) to a moisture content of 1% to 6%. The elevated temperature or toasting step can be continued until the grain pieces obtain a finish moisture content of about 1% to 6% or from about 2% to 4%.

If desired, the dried pieces can be enrobed with one or more additional components such as, for example, a sweetening component, one or more heat sensitive vitamins or the like. The grain pieces can then be packaged and distributed in conventional manner.

Bar Formation

In certain exemplary embodiments, one or more grain products described here are provided in a bar form. Methods of forming bars are well known in the art. In certain exemplary embodiments, a multiplicity of optionally enrobed, dried grain product pieces, optionally in combination with one or more additional ingredients (such as, e.g., nuts, dried fruit, chocolate pieces, marshmallows, etc.), are premixed to provide a uniform dry mixture. The resulting dry mixture is mixed with a binder system in sufficient amounts and manner to extensively distribute binder over the multiplicity of dried grain product pieces and optional additional ingredients. The resulting bar composition can be pressed and cut into bar shapes. The resulting bars can be packaged in a conventional or otherwise suitable manner for such products.

In certain exemplary embodiments, compression can be performed by spreading the mixture onto a leveled surface and applying compression from above. Any convenient suitable means can be used in this respect, such as, e.g., mold(s), pressure plate (s), compression roller(s), conveyor belt(s), etc. The compression treatment will increase the density of the mixture. For example, the compression may increase the density of the mixture by about 25 to 150 percent. In certain exemplary embodiments, the compression increases the density of the mixture from about 0.2 to about 0.4 g/cc before compression to about 0.45 to about 0.65 g/cc after compression.

A bar may be formed in any suitable shape, size and thickness. It can have a regular or irregular geometric shape. Regular geometric shapes include, but are not limited to, rectangular, square, circular, or oval cross-sections. In certain exemplary embodiments, a bar may contain a filling layer, a topping layer, or a coating or any combination of these. Although not limited thereto, the grain product bars may be cut into sizes having a weight of about 20 grams to about 100 grams.

The following example is a specific embodiment of the present invention but is not intended to limit it. The contents of all references, patents and published patent applications cited throughout this application are hereby incorporated by reference in their entirety for all purposes.

### EXAMPLE I

### Enrobed, Puffed Grain Product

It has been discovered that adding a non-sweetening amount of a potent natural sweetener to a comestible grain product can modify the taste profile of the grain product. In particular, a non-sweetening amount of a potent natural sweetener can decrease undesirable taste characteristics and/or increase desirable taste characteristics of one or more comestible grain products. The exemplary grain products disclosed here are based in part on the discovery of novel combinations of non-sweetening amounts of rebaudioside A that can be used to modify the taste profile of a comestible grain product.

The following tables discloses enrobed, puffed grain product formulations in which non-sweetening amounts of rebaudioside A were added.

TABLE 1
Total Rebaudioside A (Reb A) in Enrobed, Puffed Grain Product

| Component | 25 ppm | 50 ppm |
|---|---|---|
| % Reb A in Base (dry weight basis) | 0.0025 | 0.0025 |
| % Reb A in Syrup (wet basis) | 0.0025 | 0.0050 |
| Dry Mix Moisture % | 7.5000 | 7.5000 |
| Syrup Initial Moisture % | 22.1684 | 22.1684 |
| Finished Moisture % | 2.5000 | 2.5000 |
| Mix % Base | 53.5000 | 53.5000 |
| Mix % Syrup | 46.5000 | 46.5000 |
| Adjusted % Reb A in Base* | 0.0026 | 0.0026 |
| Adjusted % Reb A in Syrup* | 0.0030 | 0.0060 |
| Final % Reb A in Base | 0.0014 | 0.0014 |
| Final % Reb A in Syrup | 0.0014 | 0.0028 |
| Final % Reb A in Total Finished | 0.0028 | 0.0042 |
| Product | | |

*adjusted for moisture differential

TABLE 2
Formulation For Enrobed, Puffed Grain Product

| Ingredient | Amount (% by weight) |
|---|---|
| Flour | 90.000-98.000 |
| Sugar | 2.000-6.000 |
| Rebaudioside A | 0.002-0.005 |
| Artificial Sweetener | 0.004-0.015 |
| Salt & Minor Ingredients | 2.000-2.500 |

TABLE 3
Formulation for Enrobing Syrup

| Ingredient | Amount (% by weight) |
|---|---|
| Sugar | 20.000-75.000 |
| Rebaudioside A | 0.002-0.005 |
| Artificial Sweetener | 0.000-0.400 |
| Water | 20.000-55.000 |
| Flavor & Minor Ingredients | 2.000-7.500 |
| Oil | 5.000-15.000 |

Sweetened, enrobed, puffed grain products containing non-sweetening amounts of rebaudioside A were judged by a panel of taste testers to have an accentuation of total amount of flavor present (i.e., a higher flavor impact) when compared with sweetened, enrobed, puffed grain products that did not contain non-sweetening amounts of rebaudioside A.

Given the benefit of the above disclosure and description of exemplary embodiments, it will be apparent to those skilled in the art that numerous alternative and different embodiments are possible in keeping with the general principles of the invention disclosed here. Those skilled in this art will recognize that all such various modifications and alternative embodiments are within the true scope and spirit of the invention. The appended claims are intended to cover all such modifications and alternative embodiments. It should be understood that the use of a singular indefinite or definite article (e.g., “a,” “an,” “the,” etc.) in this disclosure and in the following claims follows the traditional approach in patents of meaning “at least one” unless in a particular instance it is clear from context that the term is intended in that particular instance to mean specifically one and only one. Likewise, the term “comprising” is open ended, not excluding additional items, features, components, etc.

What is claimed is:

1. A comestible grain product comprising:
at least one constituent of at least one grain; and
a non-sweetening amount of a at least one potent sweetener.

2. The comestible grain product of claim 1, wherein the potent sweetener is a potent natural sweetener comprising at least one of rebaudioside A, stevioside, monatin, mogroside V, and glycyrrhizin.

3. The comestible grain product of claim 1, wherein the potent sweetener is a potent artificial sweetener comprising at least one of aspartame, neotame, alitame, saccharin, acesulfame potassium, cyclamate, neohesperidin dihydrochalcone, and sucralose.

4. The comestible grain product of claim 1, wherein the potent sweetener is present at a concentration of about 60 PPM or less.

5. The comestible grain product of claim 1, wherein the comestible grain product is unsweetened.

6. The comestible grain product of claim 5, selected from the group consisting of oatmeal, hot cereal, multigrain hot cereal, oat bran, cracked wheat, cream of rye, cream of wheat, cream of rice, granola, muesli, and a combination of any of them.

7. The comestible grain product of claim 5, wherein the at least one grain is oat, corn, rice, wheat, barley, or a mixture of any of them.

8. The comestible grain product of claim 1, wherein the comestible grain product is sweetened with a sweetening amount of an additional sweetener.

9. The comestible grain product of claim 8, selected from the group consisting of a partially cooked ready-to-prepare cereal, an uncooked ready-to-prepare cereal, a ready-to-eat cereal and a snack bar.

10. The comestible grain product of claim 1, wherein the potent natural sweetener consists essentially of rebaudioside A present in an amount sufficient in the grain product to reduce an undesirable taste characteristic.

11. The comestible grain product of claim 10, wherein the rebaudioside A is present in an amount sufficient in the grain product to reduce an undesirable taste characteristic selected from one or more of grassy flavor, bitter flavor, grainy flavor, sour flavor and salty flavor.

12. The comestible grain product of claim 1, wherein the potent natural sweetener consists essentially of rebaudioside A present in an amount sufficient in the grain product to increase a desirable taste characteristic.

13. The comestible grain product of claim 12, wherein the desirable taste characteristic is one or both of sweetness and flavor perception.

14. The comestible grain product of claim 1, further comprising at least one additional component selected from a sweetening amount of an additional sweetener, a preservative, a color additive, a flavorant, a flavor enhancer, a fat replacer, a nutrient, an emulsifier, a stabilizer, a thickener, a binder, a texturizer, a pH control agent, an acidulant, a leavening agent, an anti-caking agent, a humectant, a dough strengthener, a dough conditioner and a combination of any of them.

15. A bar comprising the comestible grain product of claim 1.

16. A comestible grain product comprising:
a base including at least one constituent of at least one grain;
a coating enrobing at least a portion of the base; and
a non-sweetening amount of a potent sweetener present in one or both of the base and the coating.

17. The comestible grain product of claim 16, wherein one or both of the base and the coating further comprises one or more of sucrose, fructose, glucose, invert sugar and glucose-fructose syrup.

18. The comestible grain product of claim 16, wherein the at least one grain is one or more of corn, rice, wheat, oat and barley.

19. The comestible grain product of claim 16, wherein the base is in the form of puffs, flakes, shreds, clusters, sheets or any combination thereof.

20. The comestible grain product of claim 16, wherein the comestible grain product contains no sucrose, fructose, glucose, invert sugar or glucose-fructose syrup.

21. The comestible grain product of claim 16, wherein the potent sweetener consists essentially of rebaudioside A present in an amount sufficient in the grain product to reduce an undesirable taste characteristic.

22. The comestible grain product of claim 21, wherein the rebaudioside A is present in an amount sufficient in the grain product to reduce an undesirable taste characteristic is selected from one or more of grassy flavor, bitter flavor, grainy flavor, sour flavor and salty flavor.

23. The comestible grain product of claim 21, wherein rebaudioside A is present at a concentration of about 60 PPM or less.

24. The comestible grain product of claim 16, wherein the potent sweetener consists essentially of rebaudioside A present in an amount sufficient in the grain product to increase a desirable taste characteristic.

25. The comestible grain product of claim 24, wherein the desirable taste characteristic is one or both of sweetness and flavor perception.
